(19) United States
(12) Patent Application Publication
(10) Pub. No.: US 2023/0008900 A1
(43) Pub. Date: Jan. 12, 2023

(54) VEHICLE CONTROL DEVICE

(71) Applicant: ADVICS CO., LTD., Kariya-shi, Aichi-ken (JP)

(72) Inventor: Yusaku YAMAMOTO, Kariya-shi, Aichi-ken (JP)

(73) Assignee: ADVICS CO., LTD., Kariya-shi, Aichi-ken (JP)

(21) Appl. No.: 17/784,427

(22) PCT Filed: Dec. 24, 2020
(86) PCT No.: PCT/JP2020/048548

§ 371 Date: Jun. 10, 2022

(30) Foreign Application Priority Data
Dec. 25, 2019 (JP) 2019-235120

(51) Int. Cl. B60W 40/12; B60G 17/019

(52) U.S. Cl. CPC B60W 40/12; B60G 17/019; B60W 2530/00

(57) ABSTRACT

A vehicle control device includes: an acquiring unit that acquires vehicle height information from a link mechanism type vehicle height sensor that is connected to a lower arm of a suspension that connects a vehicle body and wheels of a vehicle; a storage unit that stores vehicle height error information, which is information representing a relationship between an acting force that is applied to the vehicle in a horizontal direction and an error that is contained in the vehicle height information that is output by the vehicle height sensor; and a correcting unit that corrects the vehicle height information that has been acquired by the acquiring unit, based on the acting force that acts when the vehicle height information is acquired and the vehicle height error information that is stored in the storage unit.

### TECHNICAL FIELD

The present disclosure relates to a vehicle control device.

### BACKGROUND ART

Conventionally, there is a technique in which vehicle height information is detected by a link mechanism type vehicle height sensor connected to a lower arm of a suspension that connects a vehicle body and wheels of a vehicle, and the vehicle height information is used for attitude control of the vehicle and the like.

### CITATIONS LIST

### Patent Literature

Patent Literature 1: Japanese Patent Application Laid-Open No. 2006-35937

### SUMMARY

### Technical Problems

At the time of braking or driving a vehicle, there is a case where a lower arm relatively moves in the horizontal direction in the vehicle. In this case, the accuracy of the vehicle height information detected by the vehicle height sensor may decrease.

Therefore, an object of the present disclosure is to provide a vehicle control device capable of appropriately correcting vehicle height information detected by a link mechanism type vehicle height sensor at the time of braking or driving a vehicle.

### Solutions to Problems

A vehicle control device as an example of the present disclosure includes: an acquiring unit that acquires vehicle height information from a link mechanism type vehicle height sensor that is connected to a lower arm of a suspension that connects a vehicle body and wheels of a vehicle; a storage unit that stores vehicle height error information, which is information representing a relationship between an acting force that is applied to the vehicle in a horizontal direction and an error that is contained in the vehicle height information that is output by the vehicle height sensor; and a correcting unit that corrects the vehicle height information that has been acquired by the acquiring unit, based on the acting force that acts when the vehicle height information is acquired and the vehicle height error information that is stored in the storage unit.

### BRIEF DESCRIPTION OF DRAWINGS

FIG. 1 is a block diagram illustrating a functional configuration of a vehicle control device of an embodiment and the like.

FIG. 2 is a view schematically illustrating a structure of a vehicle height sensor of the embodiment.

FIG. 3 is a view schematically illustrating (a) vehicle height error information related to braking force and (b) vehicle height error information related to driving force in the embodiment.

FIG. 4 is a top view schematically illustrating motion of a lower arm and the like in cases of (a) friction braking and (b) regenerative braking in the embodiment.

FIG. 5 is a flowchart illustrating processing by the vehicle control device of the embodiment.

### DESCRIPTION OF EMBODIMENT

An embodiment of the present disclosure will be described below with reference to the drawings. Note that the configuration of the embodiment described below, and functions and results (effects) provided by the configuration are merely examples, and the present disclosure is not limited to the following description.

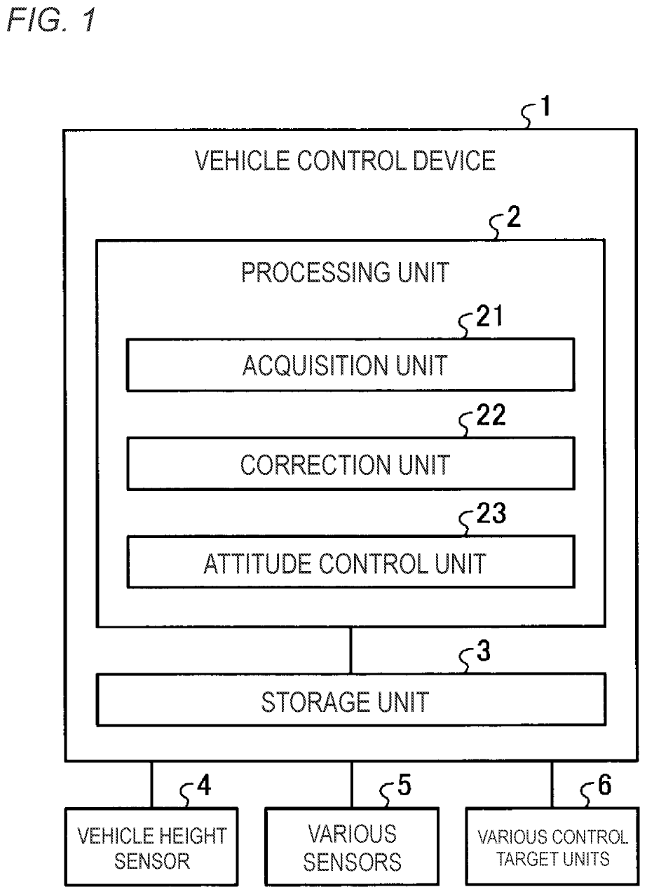

First, the functional configuration of a vehicle control device 1 of the embodiment and the like will be described with reference to FIG. 1. FIG. 1 is a block diagram illustrating the functional configuration of the vehicle control device 1 of the embodiment and the like. The vehicle control device 1 includes a processing unit 2 and a storage unit 3. A vehicle height sensor 4, various sensors 5, and various control target units 6 are connected to the vehicle control device 1.

The vehicle height sensor 4 is a link mechanism type sensor connected to a lower arm of a suspension (hereinafter, also simply referred to as “lower arm”) that connects the vehicle body and the wheels of the vehicle, and detects vehicle height information on the basis of rotational movement of the link mechanism accompanying vertical movement of the lower arm.

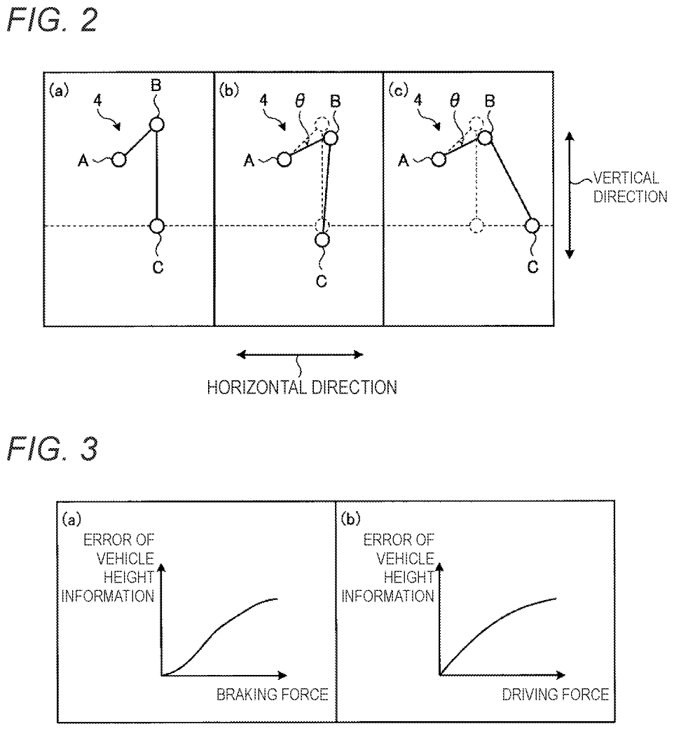

Here, FIG. 2 is a view schematically illustrating the structure of the vehicle height sensor 4 of the embodiment. The vehicle height sensor 4 includes a part A, a part B, a part C, a member AB, and a member CB. The part A is attached to the vehicle body, and the part C is attached to the lower arm. The member AB is a member connecting the part A and the part B, and the member CB is a member connecting the part C and the part B. The member AB and the member CB are made of a material having high rigidity, and do not expand and contract. The vehicle height sensor 4 has a link mechanism having the part B as a link. The vehicle height sensor 4 detects vehicle height information based on the rotational movement of the link mechanism.

For example, as illustrated in FIG. 2(b), when the lower arm moves downward, the part C attached to the lower arm also moves downward. In that case, the vehicle height sensor 4 deforms as illustrated in FIG. 2(b), and the member AB rotates by an angle θ with the part A as a rotation axis with reference to FIG. 2(a). The vehicle height sensor 4 detects vehicle height information using this angle θ.

As illustrated in FIG. 2(c), when the lower arm does not move in the vertical direction but moves in the horizontal direction, the part C attached to the lower arm also moves in the horizontal direction. In that case, the vehicle height sensor 4 deforms as illustrated in FIG. 2(c), and the member AB rotates by the angle θ with the part A as a rotation axis from the state illustrated in FIG. 2(a). The vehicle height sensor 4 detects vehicle height information using this angle θ. Therefore, even though the lower arm has not moved in the vertical direction, it is detected as if the vehicle height has changed with the change in the angle θ. In this case, the vehicle height information output by the vehicle height sensor 4 is vehicle height information including an error.

The horizontal movement of the lower arm without vertical movement occurs mainly at the time of braking or driving of the vehicle. Therefore, in the experiment in advance, in addition to the vehicle height sensor 4, a measuring instrument that measures the distance between the vehicle and the road surface by, for example, a laser, an ultrasonic wave, or the like is provided for the vehicle, and the measurement result by the measuring instrument is compared at the time of braking or driving the vehicle. The value of the vehicle height obtained by the measuring instrument is a value of the actual vehicle height because it is not affected by the horizontal movement of the lower arm. On the basis of the value of the vehicle height obtained by the measuring instrument, the vehicle height information detected by the vehicle height sensor 4, and the magnitude of the braking force and the driving force, the relationship between the degree of error contained in the vehicle height information output by the vehicle height sensor 4 and the magnitude of the braking force and the driving force is examined. Then, as vehicle height error information, data on the relationship are created using a map, a table, a function, and the like. In the present embodiment, the vehicle height error information is a map indicating the relationship between the degree of error contained in the vehicle height information detected by the vehicle height sensor 4 and the magnitude of the braking force or the driving force applied to the vehicle.

FIG. 3 is a view schematically illustrating (a) vehicle height error information related to braking force and (b) vehicle height error information related to driving force in the embodiment. Here, a case where data on the vehicle height error information have been created as a map will be described. However, the vehicle height error information is not limited to this, and a table, a function, or the like may be used.

The example of the vehicle height error information illustrated in FIG. 3(a) is a map in which the vertical axis represents the magnitude of the error of the vehicle height information and the horizontal axis represents the braking force. The example of the vehicle height error information illustrated in FIG. 3(b) is a map in which the vertical axis represents the magnitude of the error of the vehicle height information and the horizontal axis represents the driving force.

For example, regarding the braking force, the content of vehicle height error information is different between friction braking force and regenerative braking force. Specifically, even when the same braking force can be obtained by friction braking force and regenerative braking force, the horizontal movement amount of the lower arm is different. Therefore, it is preferable that data on vehicle height error information for friction braking force and data on vehicle height error information for regenerative braking force are separately created. The braking force is an example of an acting force applied to the vehicle in the horizontal direction.

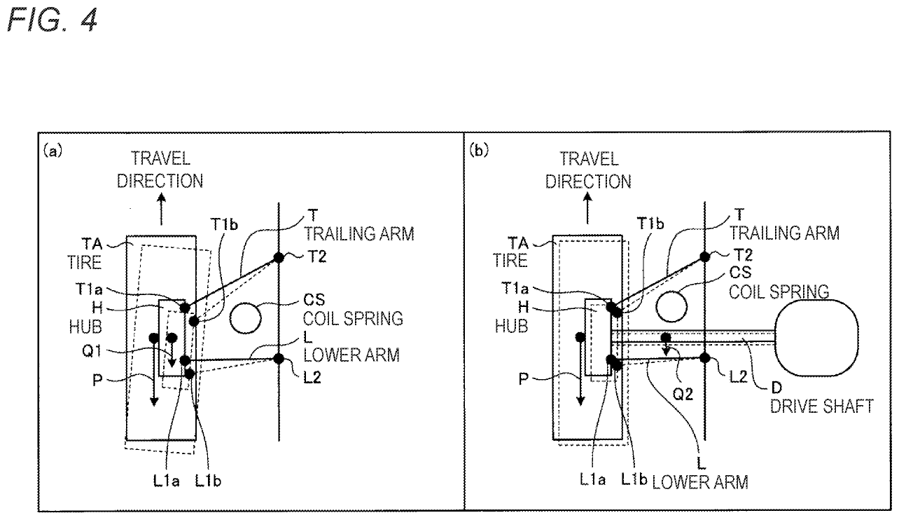

FIG. 4 is a top view schematically illustrating motion of the lower arm and the like in cases of (a) friction braking and (b) regenerative braking in the embodiment. First, a case of friction braking will be described with reference to FIG. 4(a). As illustrated in FIG. 4(a), a coil spring CS, a lower arm L, and a trailing arm T of a suspension are arranged.

Specifically, the lower arm L has an end part L1a attached to a hub H of a tire TA, and an end part L2 attached to the vehicle body. The trailing arm T has an end part T1a attached to the hub H of the tire TA, and an end part T2 attached to the vehicle body.

When the friction braking force is generated, a frictional force P acts on the tire TA from the road surface, and a force Q1 acts on the hub H. As a result, the tire TA, the hub H, the lower arm L, and the trailing arm T move from the part presented by the solid line to the part presented by the broken line. That is, in the lower arm L, the end part L1a moves to the position of a reference sign L1b. In the trailing arm T, the end part T1a moves to the position of a reference sign T1b.

Next, a case of regenerative braking will be described with reference to FIG. 4(b). As illustrated in FIG. 4(b), the coil spring CS, the lower arm L, and the trailing arm T of the suspension are arranged. A drive shaft D that transmits force is connected to the hub H.

When the regenerative braking force is generated, a force Q2 from the drive shaft D acts on the hub H of the tire TA, and a force P acts on the tire TA. As a result, the tire TA, the hub H, the lower arm L, and the trailing arm T move from the part presented by the solid line to the part presented by the broken line. That is, in the lower arm L, the end part L1a moves to the position of the reference sign L1b. In the trailing arm T, the end part T1a moves to the position of the reference sign T1b.

As seen by comparing FIG. 4(a) and FIG. 4(b), since the manner of movement of the tire TA and the hub H is different between the case of friction braking and the case of regenerative braking, the manner of movement of the lower arm L is also different. Therefore, the degree of error contained in the vehicle height information detected by the vehicle height sensor 4 in which the part C (FIG. 2) is attached to the lower arm L is also different. Therefore, as described above, it is preferable to separately create data on vehicle height error information for friction braking force and data on vehicle height error information for regenerative braking force, and to use the data differently in the case of friction braking and the case of regenerative braking.

The storage unit 3 illustrated in FIG. 1 stores vehicle height error information, which is information representing the relationship between the acting force (for example, braking force or driving force) applied to the vehicle in the horizontal direction and the degree of error contained in the vehicle height information output by the vehicle height sensor 4. For example, the storage unit 3 stores, as vehicle height error information, first vehicle height error information, which is information representing the relationship between a first braking force (for example, regenerative braking force) acting on a center part of the wheel and the degree of error contained in the vehicle height information output by the vehicle height sensor 4. For example, the storage unit 3 stores second vehicle height error information, which is information representing the relationship between a second braking force (for example, friction braking force) acting on a grounding part of the wheel and the degree of error contained in the vehicle height information output by the vehicle height sensor 4.

The storage unit 3 stores, as vehicle height error information, third vehicle height error information, which is information representing the relationship between the first driving force acting on the center part of the wheel and the degree of error contained in the vehicle height information output by the vehicle height sensor 4, for example. The storage unit 3 stores fourth vehicle height error information, which is information representing the relationship between the second driving force (for example, driving force by an in-wheel motor) acting on the grounding part of the wheel and the degree of error contained in the vehicle height information output by the vehicle height sensor 4, for example.

Note that the first to fourth vehicle height error information are created in advance by the experiment as described above.

The processing unit 2 implements each functional unit, for example, by a processor of an electronic control unit (ECU) reading and executing a program stored in a memory. Note that a part or an entirety of each functional unit may be implemented by dedicated hardware (circuit). The processing unit 2 includes, as functional units, an acquiring unit 21, a correcting unit 22, and an attitude control unit 23.

The acquiring unit 21 acquires various types of information from the vehicle height sensor 4, the various sensors 5, other ECUs, and the like. The acquiring unit 21 acquires vehicle height information from the vehicle height sensor 4, for example. The acquiring unit 21 acquires various sensor values from the various sensors 5 (sensors other than the vehicle height sensor 4). The various sensors 5 are, for example, a wheel speed sensor, an acceleration sensor, a steering angle sensor, a hydraulic sensor, a vehicle attitude sensor, and the like. The acquiring unit 21 acquires a target braking force set by an ECU (not illustrated) of a braking control device included in the vehicle control device 1. In the present embodiment, the acquiring unit 21 acquires the braking force actually acting on the vehicle on the basis of the target braking force and the sensor values of the various sensors 5. The acquiring unit 21 may also acquire the type of braking force. The type of braking force is, for example, friction braking force or regenerative braking force. The acquiring unit 21 acquires a target driving force set by an ECU (not illustrated) of a driving control device included in the vehicle control device 1. In the present embodiment, the acquiring unit 21 acquires the driving force actually acting on the vehicle on the basis of the target driving force and the sensor values of the various sensors 5. The acquiring unit 21 may store or may transmit, to the correcting unit 22, the acquired braking force or driving force into the storage unit 3. For example, the acquiring unit 21 stores the acquired vehicle height information and braking force or driving force into the storage unit 3 in association with each other. When the braking force or driving force is stored in the storage unit 3, the correcting unit 22 described later executes processing using the braking force or driving force stored in the storage unit 3 as an acting force acting when the vehicle height information is acquired. When the braking force or driving force is transmitted to the correcting unit 22, the acquiring unit 21 transmits the vehicle height information and the braking force or driving force to the correcting unit 22 in association with each other, for example. As described later, the correcting unit 22 determines whether or not the braking force or driving force has occurred on the basis of the braking force or driving force acquired by the acquiring unit 21. For example, when the braking force or driving force acquired by the acquiring unit 21 is less than a predetermined value, the correcting unit 22 determines that the braking force or driving force has not occurred.

The correcting unit 22 corrects the vehicle height information acquired by the acquiring unit 21, on the basis of the acting force (braking force, driving force, or the like) acting when the acquiring unit 21 acquires the vehicle height information and the vehicle height error information (first to fourth vehicle height error information) stored in the storage unit 3.

For example, the correcting unit 22 corrects the vehicle height information acquired by the acquiring unit 21, on the basis of the first braking force and the first vehicle height error information when the first braking force is acting at that time. For example, the correcting unit 22 corrects the vehicle height information acquired by the acquiring unit 21, on the basis of the second braking force and the second vehicle height error information when the second braking force is acting at that time.

For example, the correcting unit 22 corrects the vehicle height information acquired by the acquiring unit 21, on the basis of the first driving force and the third vehicle height error information when the first driving force is acting at that time. For example, the correcting unit 22 corrects the vehicle height information acquired by the acquiring unit 21, on the basis of the second driving force and the fourth vehicle height error information when the second driving force is acting at that time.

The attitude control unit 23 executes attitude control of the vehicle by controlling the various control target units 6 on the basis of the vehicle height information corrected by the correcting unit 22.

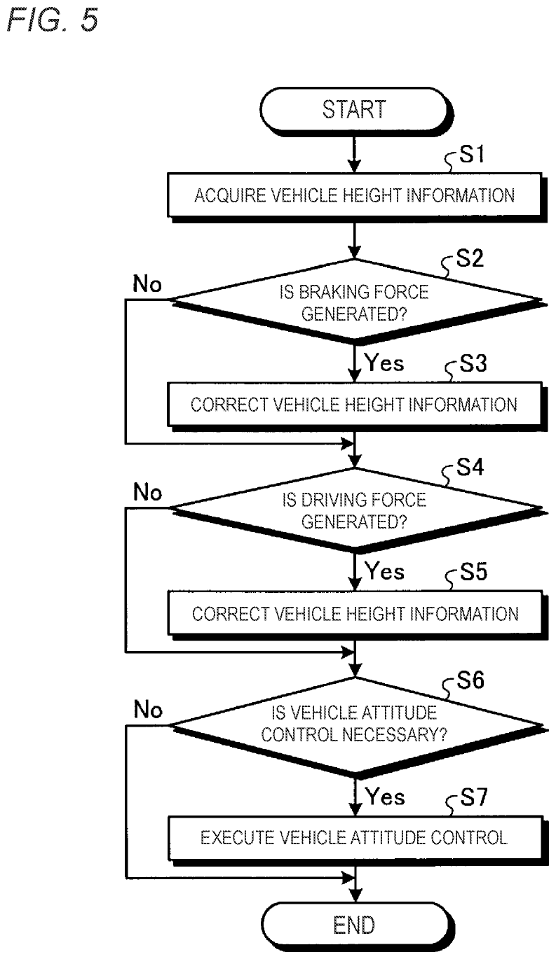

Next, processing by the vehicle control device 1 of the embodiment will be described with reference to FIG. 5. FIG. 5 is a flowchart illustrating the processing by the vehicle control device 1 of the embodiment.

First, in step S1, the acquiring unit 21 acquires vehicle height information from the vehicle height sensor 4. Next, in step S2, the correcting unit 22 determines whether or not a braking force is generated in the vehicle on the basis of sensor values from the various sensors 5 and the like. If the braking force is generated (S2: Yes), the process proceeds to step S3. If the braking force is not generated (S2: No), the process proceeds to step S4.

In step S3, the correcting unit 22 corrects the vehicle height information on the basis of the braking force being generated and the vehicle height error information stored in the storage unit 3. In step S3, the correcting unit 22 uses at least one of the first vehicle height error information and the second vehicle height error information according to the type of braking force being generated. After step S3, the process proceeds to step S4.

In step S4, the correcting unit 22 determines whether or not a driving force is generated in the vehicle on the basis of sensor values from the various sensors 5 and the like. If the driving force is generated (S4: Yes), the process proceeds to step S5. If the driving force is not generated (S4: No), the process proceeds to step S6.

In step S5, the correcting unit 22 corrects the vehicle height information on the basis of the driving force being generated and the vehicle height error information stored in the storage unit 3. In step S5, the correcting unit 22 uses at least one of the third vehicle height error information and the fourth vehicle height error information according to the type of driving force being generated. After step S5, the process proceeds to step S6.

In step S6, the attitude control unit 23 determines whether or not the attitude control of the vehicle is necessary on the basis of the vehicle height information, sensor values from the various sensors 5, and the like. If the attitude control of the vehicle is necessary (S6: Yes), the process proceeds to step S7. If the attitude control of the vehicle is not necessary (S6: No), the process ends.

In step S7, the attitude control unit 23 executes attitude control of the vehicle by controlling the various control target units 6 on the basis of the vehicle height information (vehicle height information after correction if corrected by the correcting unit 22) or the like.

As described above, according to the vehicle control device 1 of the present embodiment, since vehicle height error information is stored in the storage unit 3 in advance, when a predetermined acting force (braking force or driving force) acts on the vehicle in a case where the vehicle height information is acquired, the vehicle height information can be appropriately corrected on the basis of the acting force and the vehicle height error information. That is, by correction, it is possible to make it an appropriate value the vehicle height information representing a value different from the actual vehicle height detected by the lower arm relatively moving in the horizontal direction in the vehicle at the time of braking or at the time of driving of the vehicle. Then, by making the vehicle height information an appropriate value, it is possible to execute attitude control of the vehicle with higher accuracy.

As vehicle height error information for braking force, the vehicle height error information for friction braking force and vehicle height error information for regenerative braking force are separately stored and differently used for the case of friction braking and the case of regenerative braking, whereby the vehicle height information can be corrected with higher accuracy at the time of generation of braking force.

As vehicle height error information for driving force, the vehicle height error information for the first driving force acting on the center part of the wheel and the vehicle height error information for the second driving force acting on the grounding part of the wheel are separately stored and differently used, whereby the vehicle height information can be corrected with higher accuracy at the time of generation of driving force.

Although the embodiment of the present disclosure has been described above, the above-described embodiment is merely an example, and it is not intended to limit the scope of the disclosure. The above-described novel embodiment can be carried out in various forms, and various omissions, substitutions, or changes can be made without departing from the gist of the disclosure. The above-described embodiment and modifications thereof are included in the scope and gist of the disclosure, and are included in the disclosure described in the claims and the equivalent scope thereof.

For example, when a plurality of the vehicle height sensors 4 are installed in one vehicle, different vehicle height error information may be created for each vehicle height sensor 4.

The vehicle height error information for braking force may be separately created for hydraulic brake and electric parking brake (EPB).

The vehicle height error information may be created in consideration of other conditions such as the position of the occupant in the vehicle, the vehicle weight, the travel distance, and the travel time, and may be used according to those conditions and the situation at that time.

The acquiring unit 21 needs not associate the acquired vehicle height information with braking force or driving force. For example, the acquiring unit 21 may transmit, to the storage unit 3 and the correcting unit 22, the vehicle height information and the braking force or driving force that have been acquired at different timings. In this case, the storage unit 3 may update a table associating the current vehicle height information with the braking force or driving force every time information is received from the acquiring unit 21. The correcting unit 22 may execute processing with reference to the table stored in the storage unit 3. As described above, even when the acquiring unit 21 acquires the vehicle height information and the acting force at different timings, the correcting unit 22 may execute processing using the acting force used when correcting the vehicle height information as the acting force acting when the vehicle height information is acquired.

Step S6 and step S7 illustrated in FIG. 5 need not be executed. In this case, after the vehicle height information is corrected in step S5, the process may end. Even in this case, by correcting the vehicle height information, control or the like using the corrected vehicle height information becomes possible.

1. A vehicle control device comprising:
an acquiring unit that acquires vehicle height information from a link mechanism type vehicle height sensor that is connected to a lower arm of a suspension that connects a vehicle body and wheels of a vehicle;
a storage unit that stores vehicle height error information, which is information representing a relationship between an acting force that is applied to the vehicle in a horizontal direction and an error that is contained in the vehicle height information that is output by the vehicle height sensor; and
a correcting unit that corrects the vehicle height information that has been acquired by the acquiring unit, based on the acting force that acts when the vehicle height information is acquired and the vehicle height error information that is stored in the storage unit.

2. The vehicle control device according to claim 1, wherein the acting force is a braking force with respect to the vehicle.

3. The vehicle control device according to claim 2, wherein
the storage unit stores, as the vehicle height error information,
first vehicle height error information, which is information representing a relationship between a first braking force that acts on a center part of the wheel and an error that is contained in the vehicle height information that is output by the vehicle height sensor when the first braking force acts on a center part of the wheel, and
second vehicle height error information, which is information representing a relationship between a second braking force that acts on a grounding part of the wheel and an error that is contained in the vehicle height information that is output by the vehicle height sensor when the second braking force acts on a grounding part of the wheel, and
the correcting unit corrects
the vehicle height information that is acquired by the acquiring unit,
based on the first braking force that is acting and the first vehicle height error information in a case where the first braking force is acting, and
based on the second braking force that is acting and the second vehicle height error information in a case where the second braking force is acting.

4. The vehicle control device according to claim 1, wherein the acting force is a driving force with respect to the vehicle.

5. The vehicle control device according to claim 4, wherein
the storage unit stores, as the vehicle height error information,
third vehicle height error information, which is information representing a relationship between a first driving force that acts on a center part of the wheel and an error that is contained in the vehicle height information that is output by the vehicle height sensor when the first driving force acts on a center part of the wheel, and
fourth vehicle height error information, which is information representing a relationship between a second driving force that acts on a grounding part of the wheel and an error that is contained in the vehicle height information that is output by the vehicle height sensor when the second driving force acts on a grounding part of the wheel, and
the correcting unit corrects
the vehicle height information that is acquired by the acquiring unit,
based on the first driving force that is acting and the third vehicle height error information in a case where the first driving force is acting, and
based on the second driving force that is acting and the fourth vehicle height error information in a case where the second driving force is acting.
